(19) United States
(12) Patent Application Publication
(10) Pub. No.: US 2010/0007126 A1
(43) Pub. Date: Jan. 14, 2010

(54) Device for holding sheets in a binder which form a folded stack

(76) Inventor: Matthias Büttner, Alsting, (FR)

Correspondence Address: FRIEDRICH KUEFFNER, 317 MADISON AVENUE, SUITE 910, NEW YORK, NY, 10017, US

(21) Appl. No.: 11/990,525

(22) PCT Filed: Aug. 10, 2006
(86) PCT No.: PCT/EP2006/007912

§ 371 Date: Apr. 28, 2009

(51) Int. Cl. B42D 1/00

(52) U.S. Cl. 281/21.1

(57) ABSTRACT

The invention relates to a device for holding sheets in a binder which form a folded stack, comprising a holding element (3) connected to the spine (2) of the binder (1). According to the invention, the holding element (3) engages behind the innermost sheet of the stack (4) at its fold (9).

The invention concerns a device for holding sheets that form a folded stack in a binder, with a holding element connected with the spine of the binder.

WO 01/89859 A1 discloses a sheet binding system in which a folded stack of sheets is joined with a retaining rod that extends along the outside of the fold of the stack. This retaining rod in turn can be detachably joined with the aforesaid holding element, and several holding elements for holding one stack of sheets each can be provided in the binder. The retaining rod stabilizes the stack of sheets, so that it can also be detached from the binder, e.g., as a notebook or calendar.

The objective of the invention is to create a new holding device of the aforementioned type, which has a simplified design compared to the sheet binding system described in WO 01/89859 A1.

The device of the invention which achieves this objective is characterized by the fact that the holding element grips behind the innermost sheet of the stack at the fold.

In accordance with the invention, the holding element, which is preferably directly joined with the binder, directly grips the folded stack. To stabilize the stack, its sheets can be attached by staples in the area of the adjacent folds.

The section of the holding element that grips behind the innermost sheet has a strand-like design and in a holding position, it borders the fold along its length. This strand, which is designed, e.g., as a thin wire or thin strip, is attached on the inside against the fold of the innermost sheet and holds the stack in the binder.

The holding element can grip the stack around and behind its edge.

In a preferred embodiment of the invention, at least one opening that passes all the way through is formed in the stack or, as is especially preferred, a peripheral recess is formed in it, into which enters a section of the holding element that extends perpendicularly to the fold. The holding element grips behind the stack of sheets, i.e., it either grips behind at the edge or grips behind a passage formed in the stack. As a result of the engagement of the aforesaid section in the peripheral recess or passage, the stack is secured against displacement perpendicularly to the fold, which is advantageous especially when the stack is opened together with the binder, and the opened stack could be laterally displaced towards the binder without this engagement.

The opening or peripheral recess is preferably formed symmetrically to the fold, i.e., to a plane which perpendicularly intersects the stack on the fold line in the opened state.

In a further refinement of the invention, the holding element comprises a carrier rail, which is joined with the spine of the binder and can also be integrated in the binder.

The aforementioned perpendicular section of the holding element can be joined with this carrier rail and/or it can be formed as an angled section of the aforesaid strand-like section.

The strand-like section preferably can be removed from its holding position, in which it borders on the fold and extends parallel to it, to allow removal of the stack of sheets from the binder by, for example, swiveling the section into a position perpendicular to the fold or displacing it parallel to the fold. The strand-like section preferably can be removed from the holding position against the action of spring tension, such that the strand-like section itself can be elastically deformed and can be formed, e.g., by a rubber band.

The invention is explained in greater detail below with reference to the specific embodiments illustrated in the accompanying drawings.

FIG. 1 shows a folded block, which is held in a leather binder by a device in accordance with the invention,

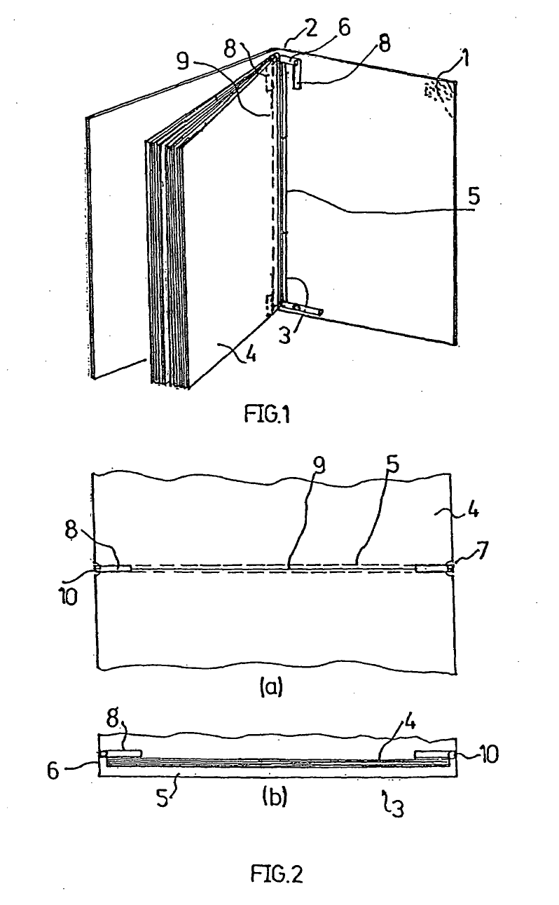

FIG. 2 shows details of the holding device of FIG. 1,

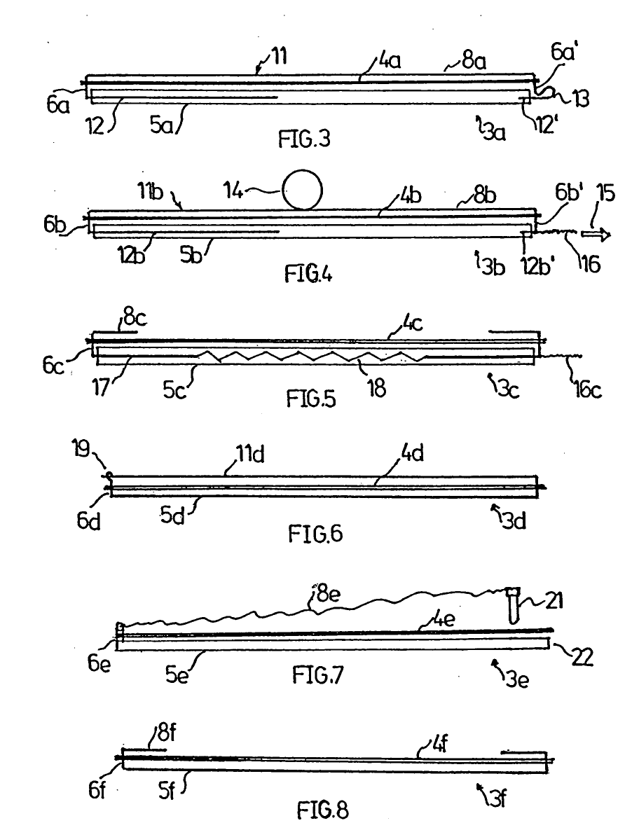

FIGS. 3 to 9 show schematic representations of further embodiments of holding devices of the invention,

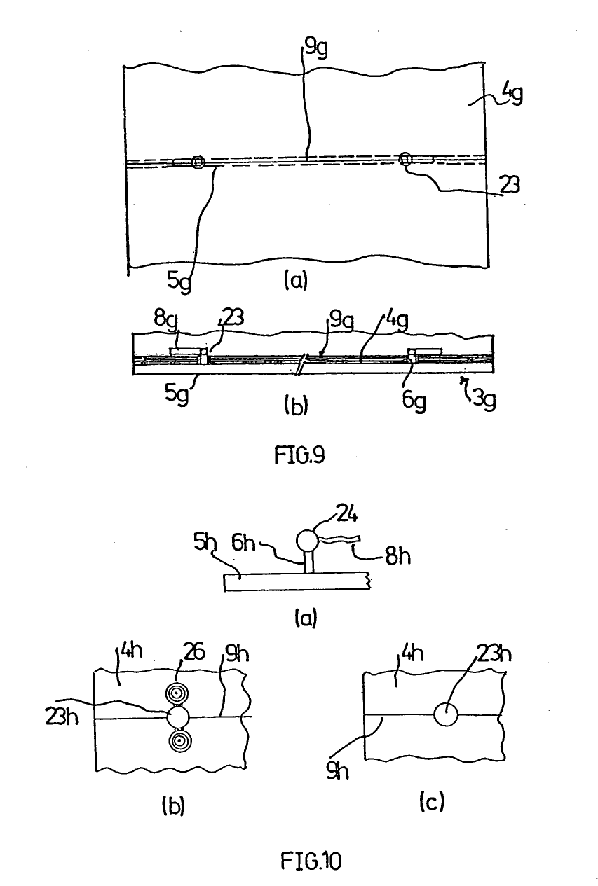

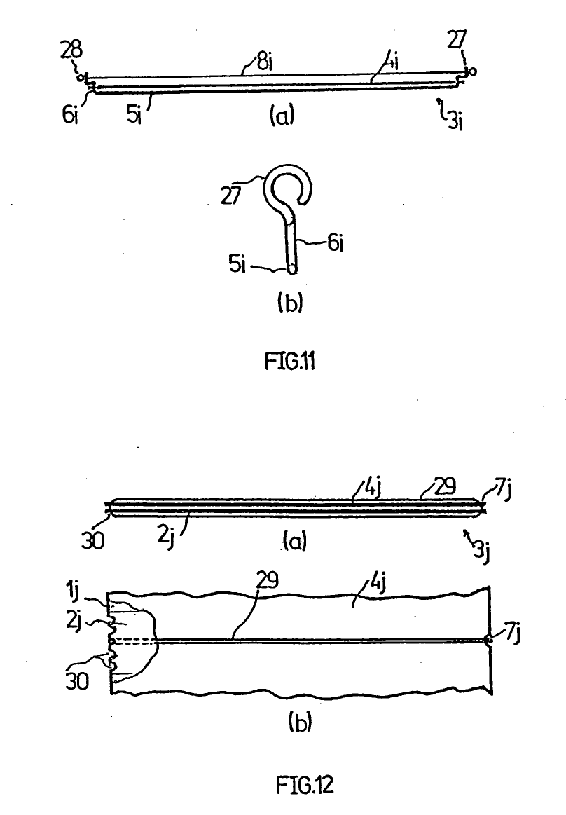

FIG. 10 shows a partial view of another embodiment of a holding device of the invention, and

FIGS. 11 and 12 show further embodiments of holding devices according to the invention.

The leather binder 1 shown in FIG. 1 has holding elements 3 mounted on the inside on the binder spine 2 for holding a stack of sheets 4 folded at 9 inside the leather binder.

In the illustrated embodiment, two holding elements 3 are provided in the leather binder 1. One of these holding elements 3 holds the stack of sheets 4 shown in the drawing. Another stack of this type could be held by the other holding element. In a modification of this specific embodiment, additional holding elements could be provided.

Each holding element consists of a carrier rail 5 sewn together with the spine 2 of the leather binder 1. An angled section 6 is formed at each end of the carrier rail 5. The angled sections 6 extend through peripheral recesses 7 formed in the stack of sheets 4. An end piece 8 is formed at the free end of each angled section 6 and can swivel about a joint 10. Along its length, the end piece 8 borders the fold 9 opposite the stack of sheets 4 and holds the stack of sheets on the carrier rail. The joint 10 can have a stiff design or it can lock in the swivel position shown in FIG. 2.

As a result of the angled sections 6 that engage the peripheral recesses 7 and extend perpendicularly to the fold 9, the stack of sheets 4 is secured in the direction perpendicular to the fold 9, which prevents an undesired lateral displacement of the stack of sheets 4, especially in the folded-up state.

In the illustrated embodiment, the peripheral recess 7 is semicircular. It could also be triangular or it could be adapted to the cross-sectional shape of the peripheral angled section that engages it.

By bringing the end pieces 8 into a position perpendicular to the fold 9 of the stack of sheets 4, the stack of sheets can be detached from the holding device 3 to allow it to be used independently of the binder. In this position of the end pieces 8, the stack of sheets can also be reinserted and reattached to the carrier rail 5 by swiveling the end pieces 8 into the position shown in FIG. 2.

In the following figures, parts that are the same or have the same function are labeled with the same reference numbers as in FIGS. 1 and 2 but with an appended letter a, b, c . . . , etc.

The holding element 3a shown in FIG. 3 has a carrier rail 5a that is joined, e.g., with a leather binder. The carrier rail 5a is constructed as a tube that is open at its ends and is connected with a retaining clip 11 made of spring wire, and a folded stack of sheets 4a is enclosed between the retaining clip 11 and the carrier rail 5a.

The retaining clip 11 made of spring wire has a section 8a, which rests against the stack of sheets 4a at its fold and to which angled sections 6a and 6a′ are attached. The angled sections 6a and 6a′ extend perpendicularly to the fold of the stack of sheets 4a, and peripheral recesses of the stack of sheets 4a engage corresponding peripheral recesses 9.

Attached to the angled section 6a is an end piece 12, which is arranged at an angle of 90° to the angled section 6a and enters an opening at the end of the tubular rail 5a. The angled section 6a′ is connected with a loop 13, which makes a transition into an end piece 12′, which, like the end piece 12, enters an opening at the end of the tubular rail 5a.

To release the connection between the stack of sheets 4a and the rail 5a, the user grips the loop 13 and pulls the end piece 12a, which is much shorter than the end piece 12, out of the tubular carrier rail 5a. The retaining clip 11 can now be bent aside to release the stack of sheets 4a from the carrier rail 5a and moved in the opposite direction, which causes the end piece 12 to come out of the rail 5a.

FIG. 4 shows a holding element 3b that is similar to the holding element of FIG. 3. In this case, a clip 11b made of spring wire with angled sections 6b and 6b′ has a loop 14 in the longitudinal center of a section 8b that rests against a stack of sheets 4b, which makes it possible to stretch section 8b in the direction indicated by the arrow 15.

To release the retaining clip 11b from the carrier rail 5b, a user can pull a strip 16 connected with the retaining clip 11b in the direction of the arrow 15.

A retaining element 3c shown in FIG. 5 has a retaining wire 17 made of spring steel, which is laid over most of its length through a tubular carrier rail 5c and is wound to form a spring segment 18 inside the carrier rail. End pieces 8c angled once again 90° from angled sections 6c hold a stack of sheets 4c on the carrier rail 5c. When a user pulls the pull strip 16c, the stack of sheets 4c is released from the clasp of the respective end piece 8c and can then be removed from the binder.

A holding element 3d shown in FIG. 6 for holding a stack of sheets 4d has a carrier rail 5d that is formed as a single piece with a retaining clip 11d made of spring steel wire. The retaining clip 11d can be hung on an angled end section 6d of the carrier rail 5d at 19 in the manner of a safety pin.

A holding element 3e shown in FIG. 7 has a carrier rail 5e with an angled end section 6e, whose free end is connected with an elastically stretchable band 8e, e.g., a rubber band. A pin 21 is attached to the end of the rubber band 8e that faces away from the angled end section 6e. The pin 21 can be pushed into an opening in the end of the tubular carrier rail 5e under tension of the rubber band 8e and placement of the rubber band against the inner fold of the stack of sheets 4e.

A holding element 3f shown in FIG. 8 for holding a stack of sheets 4f is formed as a single piece from spring wire to form a carrier rail 5f with angled sections 6f and with end pieces 8f further angled from the angled sections 6f.

Reference is now made to FIG. 9, which shows an embodiment of a holding element 3g for holding a folded stack of sheets 4g, in which two passages 23 are formed in the stack of sheets 4g instead of the peripheral recesses provided in the preceding embodiments. A pin 6g that extends perpendicularly to the fold 9g and is connected with the carrier rail 5g fits into each of the passages 23. An end piece 8g can be swiveled about a joint 10g, so that it rests against the fold 9g of the stack of sheets 4g and grips behind the stack of sheets to connect it with the rail 5g.

Naturally, instead of swiveling end pieces 8g, a band, possibly one that is elastic, which connects the projecting pins 6g, could be used to hold the stack of sheets 4g on the carrier rail 5g.

Reference is now made to FIG. 10. A partially drawn carrier rail 5h has a pin 6h with a spherical head 24. Another pin of this description (not shown) is arranged some distance from the pin 6h. A rubber band 8h stretched between the spherical heads 24 of the pins holds the stack of sheets 4h on the carrier rail 5h.

Passages 23h with a width equal to the diameter of the spherical heads 24 are formed in the stack of sheets 4h.

Some of the sheets in the stack of sheets 4h have only the hole 23h visible in FIG. 10c, these being the sheets facing the spine of the binder. The sheets of the stack that follow these sheets have holes 26 symmetrical to the fold 9h with a width that increases from sheet to sheet.

In the state in which the sheets are folded by 90°, the spherical head 24 fills the cavity formed by the holes 26 in the stack of sheets 4h. In the folded-up state, after the rubber band 8h has been removed, the stack of sheets 4h can be detached from the carrier rail 5h by passing the spherical heads 24h through the holes 23h.

Another holding element 3i shown in FIG. 11 has a carrier rail 5i with angled sections 6i. Each of these angled sections follows two other angled sections, which include angled end sections that are formed as eyes 27. An elastically stretchable band 8i can be hung in the eyes 27, and spherical end pieces 28 grip behind the eyes 27. The eyes form a seat for the end pieces which centers the end pieces.

FIG. 12 shows a holding element 3j that consists exclusively of a stretchable, closed band 29. The band engages peripheral recesses 7j in a stack of sheets 4j. The ends of a spine 2j of a binder 1 have corresponding peripheral recesses 30 for receiving the band 29. In the open state of the binder 1j and the stack of sheets 4j, the peripheral recesses 7j and 30 prevent both the band 29 and the stack of sheets 4j from shifting laterally on the binder 1j. As FIG. 12b shows, several peripheral recesses 30 are formed on the spine of the binder, corresponding to the number of stacks of sheets to be held in the binder.

The band 29 can be enclosed between two layers of the spine of the binder, so that it is not visible from the outside.

In particular, the inner layer of the two layers could be detachably fastened to the other layer, e.g., by snap fasteners.

The band 29 does not have to be closed. The ends of an open band could be firmly connected with the spine of the binder.

1. A device for holding sheets that form a folded stack (4) in a binder (1), with a holding element (3) connected with the spine (2) of the binder (1), wherein the holding element (3) grips behind the innermost sheet of the stack (4) at the fold (9).

2. A device in accordance with claim 1, wherein the section (8) of the holding element (3) that grips behind the innermost sheet of the stack (4) has a strand-like design and in a holding position, it borders the fold (9) along its length.

3. A device in accordance with claim 1, wherein at least one opening (23) that passes all the way through or at least one peripheral recess (7) is formed in the stack (4), where a section (6) of the holding element (3) that extends perpendicularly to the fold (9) enters this passage (23) or peripheral recess (7).

4. A device in accordance with claim 3, wherein the opening (23) or peripheral recess (7) is formed symmetrically to the fold (9).

5. A device in accordance with claim 1, wherein the holding element (3) comprises a carrier rail (5), which is joined with the spine (2) of the binder (1).

6. A device in accordance with claim 3, wherein the section (6) of the holding element (3) that extends perpendicularly to the fold (9) is connected with the carrier rail (5) and/or is formed as an angled section of the strand-like section (8).

7. A device in accordance with claim 2, wherein the strand-like section (8) can be removed from the aforementioned holding position, possibly by swiveling or displacement, in order to detach the stack (4) from the binder (1).

8. A device in accordance with claim 7, wherein the strand-like section (8a-8f) can be removed from the holding position against the action of spring tension.

9. A device in accordance with claim 2, wherein the strand-like section (8a-8f) can be elastically deformed.

10. A device in accordance with claim 1, wherein widening pins (6h), which are connected with the strand-like section (8h), project from the carrier rail (5h), and the sheets have holes (26) that widen in such a way that a space for receiving the widened pin (6h) is formed in the stack that has been folded by 90°.

11. A device in accordance with claim 1, wherein the holding element (3s) consists exclusively of an elastic band (29).

12. A device in accordance with claim 11, wherein the band (29) is closed and spans, besides the stack of sheets (4), at least an inner layer of the spine (2) of the binder.

13. A device in accordance with claim 1, wherein the holding element (3j) is secured on the binder (1j) against displacements transverse to the spine (2j).

14. A device in accordance with claim 13, wherein the holding element (3j) engages a peripheral recess (30) formed on the spine (2j) of the binder (1j).
